(19) United States
(12) Patent Application Publication
(10) Pub. No.: US 2019/0093924 A1
(43) Pub. Date: Mar. 28, 2019

(54) WATER-PURIFYING DEVICE AND METHOD FOR CONTROLLING THE WATER-PURIFYING DEVICE

(71) Applicant: LG ELECTRONICS INC., Seoul (KR)

(72) Inventor: Min Ki KIM, Seoul (KR)

(73) Assignee: LG ELECTRONICS INC.

(21) Appl. No.: 16/059,459

(22) Filed: Aug. 9, 2018

(30) Foreign Application Priority Data
Sep. 26, 2017 (KR) 10-2017-0124510

(51) Int. Cl. F24H 9/20; F24H 7/00; H05B 1/02; H05B 6/06

(52) U.S. Cl. CPC F24H 9/2021; F24H 7/002; H05B 1/0283; H05B 2206/02; C02F 2307/10; F24H 2250/08; H05B 6/06

(57) ABSTRACT

The present disclosure relates to a water-purifying device and a method for controlling the water-purifying device. In order to maintain a hot-water discharge temperature of water in the hot-water storage tank upon a hot-water discharge request from a user, an upper-limit temperature and lower-limit temperature corresponding to the hot-water discharge temperature are determined. Thus, the water-purifying device according to the present disclosure may drive a heating module thereof based on the upper-limit temperature and lower-limit temperature.

### CROSS-REFERENCE TO RELATED APPLICATION

This application claims priority under 35 U.S.C. § 119 to Korean Application No. 10-2017-0124510, filed on Sep. 26, 2017, whose entire disclosure is hereby incorporated by reference.

### BACKGROUND

### 1. Field

The present disclosure relates to a water-purifying device and a method for controlling the water-purifying device.

### 2. Background

A water-purifying device is configured to remove harmful components such as foreign substances or heavy metals contained in water using physical or chemical methods. Generally, the water-purifying device includes a filter for filtering contaminants from raw-water containing the contaminants, a purified-water tank for storing purified-water passing through the filter, and a water-discharge unit for discharge the purified-water stored in the tank to the outside. When the water-purifying device is powered, raw-water is supplied to the filter, where water is purified, and, then purified water is stored in the water-tank. The stored purified water is discharged to the outside through the water-discharge unit depending on the user's selection. In recent years, direct-discharge type water-purifying devices have been used in which the purified-water is directly discharged through the water-discharge unit without being stored in the separate tank space.

In addition to simply purifying the raw water, the water-purifying device also often has an ability to cool or heat the purified water to provide cold-water and/or hot-water. In particular, the water-purifying device with the hot-water supply function includes a water storage for storing water therein, and a heating module for heating the water stored in the water storage to a predetermined hot-water discharge temperature. In particular, in recent years, the heating module included in the water-purifying device includes an induction-heating type heating module for heating water via flowing a resonance current to a working coil in accordance with a switching operation of a switching element.

The conventional water purifying device typically senses a temperature of water stored in the water storage using a temperature sensor provided in the water storage such that as the user desires, the hot-water having the predetermined hot-discharge temperature may be discharged. When the user requests a hot-water discharge, the water-purifying device drives the heating module according to a predetermined operating frequency until the sensed temperature of the water in the water storage reaches a predetermined hot-water discharge temperature.

However, even after the temperature of the water in the water storage reaches the hot-predetermined hot-water discharge temperature, the conventional water-purifying device should continue to drive the heating module in order to maintain the temperature of the water in the water storage at the hot-water discharge temperature. When the heating module is continuously driven, the switching loss due to the continuous switching operation of the switching element included in the heating module occurs, thereby reducing the power efficiency and increasing the possibility of the burn-out of the switching element. Further, there is a problem that the switching noise due to the switching operation of the switching element is continuously generated.

### BRIEF DESCRIPTION OF THE DRAWINGS

The embodiments will be described in detail with reference to the following drawings in which like reference numerals refer to like elements wherein:

FIG. 1 is a perspective view of a water-purifying device according to one embodiment of the present disclosure;

FIG. 2 is a diagram illustrating a process of heating water in a hot-water storage of a water-purifying device according to an embodiment of the present disclosure;

FIG. 3 is a circuit diagram of a heating module according to one embodiment of the present disclosure;

FIG. 4 is a temperature table showing an upper-limit temperature and a lower-limit temperature corresponding to a hot-water discharge temperature, according to one embodiment of the present disclosure;

FIG. 5 is a flow chart of a method for controlling a water-purifying device according to one embodiment of the present disclosure;

FIG. 6 is a graph showing a temperature change of water over time when a conventional water purifying device heats water in a hot-water storage;

FIG. 7 is a graph showing a change in power consumption over time when a conventional water purifying device heats water in a hot-water storage;

FIG. 8 is a graph showing a change in a switching signal over time when a conventional water purifying device heats water in a hot-water storage;

FIG. 9 is a graph showing a temperature change of water over time as the water-purifying device according to the present disclosure heats water in a hot-water storage;

FIG. 10 is a graph showing a change in power consumption over time when the water-purifying device according to the present disclosure heats water in a hot-water storage;

FIG. 11 is a graph showing a change in a switching signal over time when the water-purifying device according to the present disclosure heats water in the hot-water storage;

FIG. 12 is a graph showing a frequency band as covered by a filter circuit used in the conventional water purifying device; and

FIG. 13 is a graph showing a frequency band as covered by a filter circuit used in the water purifying device according to the present disclosure.

### DETAILED DESCRIPTION

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

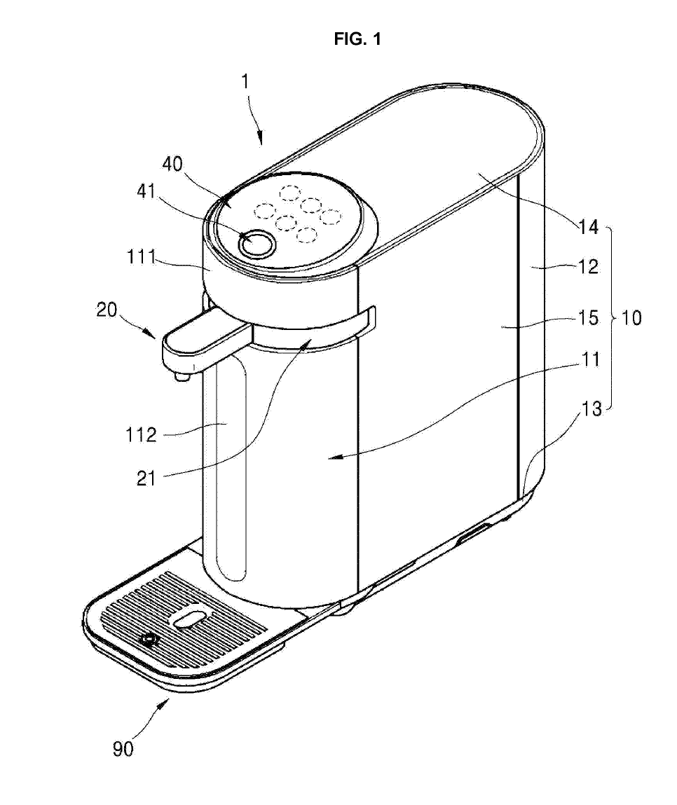

FIG. 1 is a perspective view of a water-purifying device according to one embodiment of the present disclosure. As illustrated, the water purifying device 1 according to one embodiment of the present disclosure is formed to have a large length in a front-rear direction and a small width in a left-right direction. Thus, the water-purifying device 1 according to the present disclosure may have a slim and compact appearance.

An appearance of the water-purifying device 1 is formed by a casing 10. The casing 10 may include a front cover 11 defining a front face of the water purifying device 1, a rear cover 12 defining a rear face of the water purifying device 1, a base 13 defining a bottom face of the water purifying device 1, a top cover 14 defining the top face of the water-purifying device 1, and both side panels 15 defining left and right-side faces of the water-purifying device 1 respectively. The front cover 11, the rear cover 12, the base 13, the top cover 14 and the both side panels 15 may be joined together to define the appearance of the water-purifying device 1.

On a portion of the top cover 14, a manipulation interface (or user interface) 40 is arranged. The manipulation interface 40 includes a discharge button 41 that may be pressed when the user wants to discharge water. The interface 40 may be configured to display various information related to the water purifying device 1 or to allow the user to select related functions. The interface includes a touch panel 40. However, the present disclosure is not limited thereto.

The user may press the discharge button 41 to cause the discharge of water through the water-discharge unit 20 to begin. Further, when a desired amount of water has been discharged, the user may push the discharge button 41 again to cause the discharge of water to stop. In one embodiment, the user may keep pressing the discharge button 41 until the desired amount of water is discharged.

The user may select or input a current discharge mode (cold-water or hot-water) of the water purifying device via the touch panel 40 or select or input a target temperature of the water to be discharged via the touch panel. For example, the user selects a hot-water discharge mode via a discharge mode selection button. The user may directly input a temperature of the hot-water to be discharged, that is, a hot-water discharge temperature. In one embodiment, the hot-water discharge temperature may be preset in a manufacture of the water-purifying device 1.

The water-discharge unit (also referred to herein has a nozzle or outlet) 20 is placed in front of the front cover of the water-purifying device 1. The water-discharge unit 20 protrudes forward of the front cover 11, and the outlet 20 has a discharge nozzle protruding downward. The purified-water is discharged through the discharge nozzle.

The water-discharge unit 20 is operatively connected to a rotator 21. The rotator 21 rotates within the water purifying device 1, thereby allowing the water-discharge unit 20 to rotate within a certain angle. Accordingly, the user may rotate the water-discharge unit 20 at a desired angle depending on an installation state or installation environment of the water purifying device 1. In this regard, the manipulation interface 40 provided on the top cover 14 may also be rotated together with the outlet 20.

A tray 90 is connected to the base 13. The tray 90 protrudes forward of the front cover 11, and the tray is positioned vertically below the water-discharge unit 20. The tray 90 may be rotated by the user's manipulation, and the tray may be separated from the base 13. The tray 90 receives water falling from the water-discharge unit 20 so that the water does not flow to the outside. To this end, a top face of the tray may be formed in a grill shape.

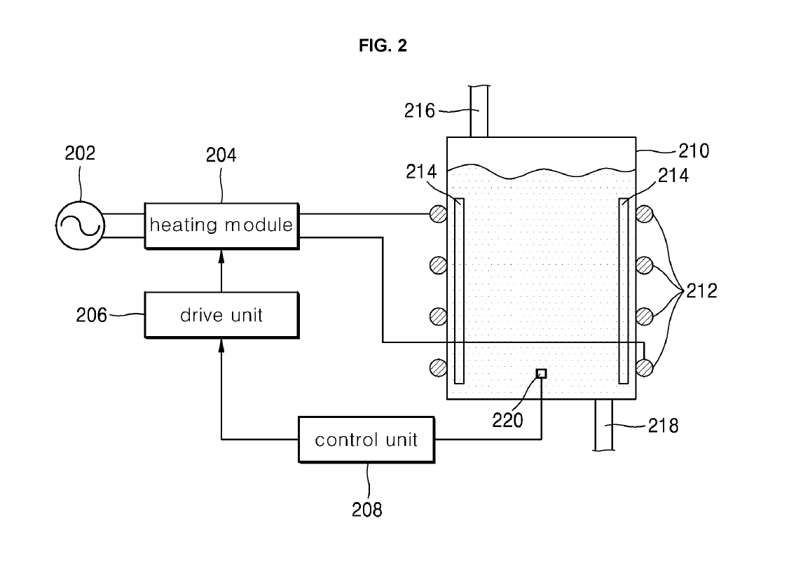

Although not illustrated in FIG. 1, a hot-water storage 210 (see FIG. 2) may be provided inside the water-purifying device 1. Into the hot-water storage, purified-water may be introduced through a filter (not shown) provided inside or outside the water purifying device 1. When the user requests hot-water discharge, the water previously entering the hot-water storage may be heated by a heating module 204 (see FIG. 2) until the water reaches the hot-water discharge temperature.

The heating module 204 is configured to heat the purified-water in the hot-water storage. The heating module is configured to heat water in an inductive-heating (IH) manner. When using the inductive-heating (IH) based heating module, the device may heat the water immediately and quickly when the user requests the hot-water discharge.

FIG. 2 is a diagram illustrating a process of heating water in a hot-water storage of a water-purifying device according to an embodiment of the present disclosure. Referring to FIG. 2, a water purifying device according to an embodiment of the present disclosure includes a heating module (or resonant current generation circuitry) 204, a drive unit (or drive circuitry) 206, a control unit (or controller) 208, and a hot-water storage (or hot-water storage tank) 210.

The hot-water storage 210 stores therein purified-water from a filter (not shown). At one side of the hot-water storage 210, a water inlet 216 receiving the purified-water flows from filter (not shown) is provided. Further, at the other side of the hot-water storage 210, a water-outlet 218 for delivering the heated water in the hot-water storage 210 to the water-discharge unit at the user's request of the hot-water discharge is arranged.

A working coil 212 for heating the water in the hot-water storage 210 is wound around an outer face of the hot-water storage 210. Further, in the hot-water storage 210, an inductive-heated object 214 as heated by the working coil 212 is provided. The inductive-heated object 214 may be made of a magnetic material. When a resonant current provided by the heating module 204 flows through the working coil 212, the magnetic field may be generated in the working coil 212 such that an eddy current is generated in the inductive-heated object 214. In this way, the temperature of the inductive-heated object 214 rises. As the temperature of the inductive-heated object 214 rises, the water in the hot-water storage 210 is heated.

Further, inside the hot-water storage 210, a temperature sensor 220 for sensing the temperature of water in the hot-water storage 210 is provided. The temperature of the water measured by the temperature sensor 220 is transmitted to the control unit 208.

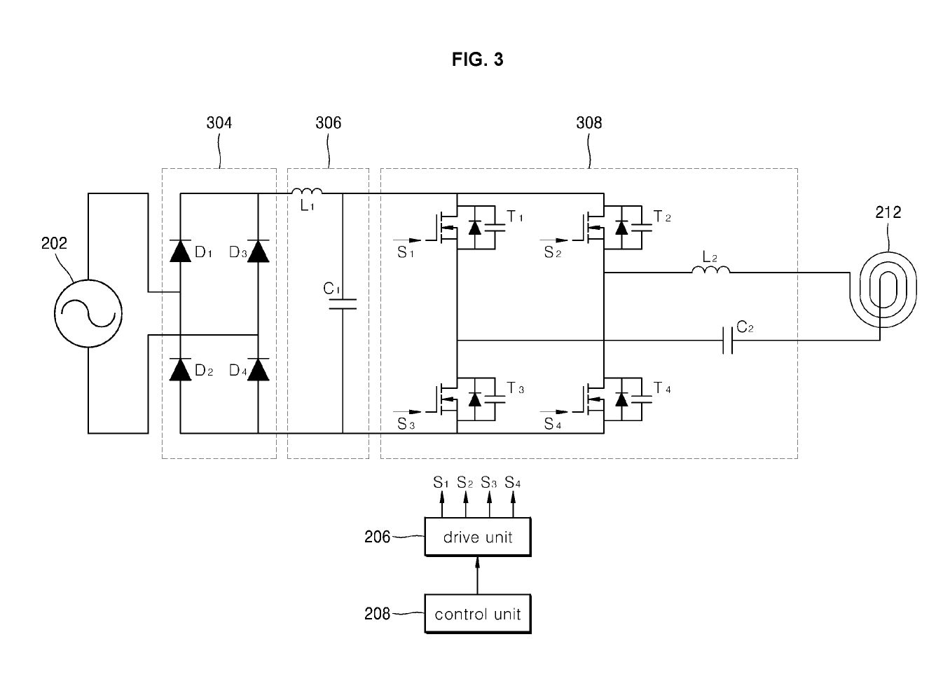

The heating module 204 converts the power supplied by an external power source 202. The heating module then generates the resonant current for the heating operation of the working coil 212 using the converted power. To this end, within the heating module 204, one or more switching elements may be provided for generating the resonant current. An internal structure of the heating module 204 will be described later with reference to FIG. 3.

The drive unit 206 generates, in response to a receipt of a control signal supplied from the control unit 208, a switching signal for driving the heating module 204. The drive unit 206 generates the switching signal based on an operating frequency set by the control unit 208. The switching signal causes the heating module 204 to operate at the operating frequency. To this end, one or more switching elements may be provided in the heating module 204 and may be complementarily turned on and off based on the switching signal provided by the drive unit 206. Such complementary turn-on and turn-off operations of the switching elements may be referred to as switching operations.

The control unit 208 controls the supply of the resonant current to the working coil 212 from the heating module 204 based on the temperature of the water as measured by the temperature sensor 220 provided within the hot-water storage 210. When the hot-water discharge is requested from the user, the control unit 208 causes the drive unit 206 to drive or stop the heating module 204 such that the water inside the hot-water storage 210 is heated based on the predetermined hot-water discharge temperature.

According to the present disclosure, the hot-water discharge temperature refers to a temperature that water to be discharged should have when the user requests the hot-water discharge. The hot-water discharge temperature may be preset at the time of manufacturing the water-purifying device. Alternatively, the hot-water discharge temperature may be set directly by the user during use of the water-purifying device.

In one embodiment of the present disclosure, the control unit 208 determines an upper-limit temperature and a lower-limit temperature corresponding to the hot-water discharge temperature. The control unit 208 controls the supply of the switching signal from the drive unit 206 to the heating module 204 based on the determined upper-limit temperature and lower-limit temperature.

If the temperature of the water inside the hot-water storage 210 is equal to or above the upper-limit temperature, the control unit 208 may stop the drive unit 206 so that the switching signal is not supplied to the heating module 204. Conversely, if the temperature of the water inside the hot-water storage is equal to or below the lower-limit temperature, the control unit 208 may drive the drive unit 206 such that the switching signal is supplied to the heating module 204.

According to the present disclosure, while the heating operation for heating water in the hot-water storage 210 is performed under the control by the control unit 208, the operation frequencies corresponding to the switching operations of the switching elements provided in the heating module 204 may be kept to be equal to each other for all of the spaced temporal heating periods. Further, according to the present disclosure, the upper-limit temperature and the lower-limit temperature corresponding to the hot-water discharge temperature may be set as follows: When water having the upper-limit temperature and water having the lower-limit temperature are mixed with each other, the mixed water may have the hot-water discharge temperature. In other words, when mixing the water with the upper-limit temperature and the water with the lower-limit temperature, the temperature of the mixed water matches the hot-water discharge temperature.

Although not illustrated in the figures, in other embodiments of the present disclosure, a current interrupter may be provided between the heating module 204 and the drive unit 206. The current interrupter may include a relay. The control unit 208 may control the current interrupter instead of driving or stopping the drive unit 206, to control the supply of the switching signal to the heating module 204 based on the upper-limit temperature and the lower-limit temperature as described above.

That is, if the temperature of the water inside the hot-water storage 210 is equal to or above the upper-limit temperature, the control unit 208 may open the relay in the current interrupter so that the switching signal is not supplied to the heating module 204. As a result, the supply of the switching signal from the drive unit 206 to the heating module be deactivated. Conversely, if the temperature of the water inside the hot-water storage is equal to or below the lower-limit temperature, the control unit 208 may close the relay in the current interrupter so that the switching signal is supplied to the heating module 204. Thus, the switching signal may be supplied from the drive unit 206 to the heating module. When such a current interrupter is provided, the drive unit 206 continues to run without stopping, and only the current interrupter is controlled by the control unit 208 while the hot-water discharge is requested by the user.

FIG. 3 is a circuit diagram of a heating module 204 according to one embodiment of the present disclosure. Referring to FIG. 3, a heating module 204 according to an embodiment of the present disclosure includes a rectifying unit (or rectifying circuit) 304, a smoothing unit (or smoothing circuit) 306, and an inverter 308.

The rectifying unit 304 rectifies AC input power supplied from the external power source 202 and outputs the rectified power source voltage. To this end, the rectifying unit 304 may include a plurality of diodes. For example, the rectifying unit 304 may include a first diode D₁ and a second diode D₂ connected in series with each other, and a third diode D₃ and a fourth diode D₄ connected in series with each other.

The smoothing unit 306 may be configured to receive and smooth the power supply voltage rectified by the rectifying unit 304 and outputs the smoothed DC voltage. The smoothing unit 306 may be composed of an inductor L₁ and a capacitor C₁ connected in series with each other.

The inverter 308 includes a plurality of switching elements. In one embodiment of the present disclosure, the inverter 308 includes four switching elements: a first switching element T₁, a second switching element T₂, a third switching element T₃, and a fourth switching element T₄.

The first switching element T₁ and the second switching element T₂ are connected in series with each other. The first switching element T₁ and the second switching element T₂ are complementarily turned on and off in response to the switching signals S₁ and S₂ applied by the drive unit 12 respectively, which will be described later. Likewise, the third switching element T₃ and the fourth switching element T₄ are connected in series with each other. The third switching element T₃ and the fourth switching element T₄ are complementarily turned on and off in response to the switching signals S₃, and S₄ applied by the drive unit 12, respectively.

The complementary turn-on and turn-off operations of such switching elements are referred to as switching operations. The inverter 308 converts the DC voltage provided by the smoothing unit 306 into an AC voltage via the switching operations of the switching elements T₁, T₂, T₃ and T₄, and outputs the AC voltage.

Further, in order to convert the AC voltage output via the switching operations of switching elements into a resonant current, the inverter 308 includes an inductor L₂ and a capacitor C₂. The inductor L₂ and the capacitor C₂ are connected in series with the working coil 212. The inductor L₂ and the capacitor C₂ are resonated using the alternating voltage provided via the switching operations of the switching elements. As a result, the resonant current is supplied to the working coil 212.

The working coil 212 heats an object placed around the working coil 212 using the resonant current provided from the inverter 108. When the resonant current is applied to the working coil 212, the magnetic field may be generated by the working coil 212 and, then, an eddy current may be generated in the inductive-heated object 214 illustrated in FIG. 2, thereby causing the temperature of the inductive-heated object 214 to rise. As the temperature of the inductive-heated object 214 rises, the water inside the hot-water storage 210 is heated up.

The drive unit 206 generates, in response to the control signal transmitted from the control unit 208, the switching signals S₁, S₂, S₃, and S₄ to be applied to the switching elements T₁, T₂, T₃, and T₄. The operating frequencies of the switching elements T₁, T₂, T₃, and T₄ are determined based on waveforms of the switching signals S₁, S₂, S₃, and S₄ as generated by the drive unit 206.

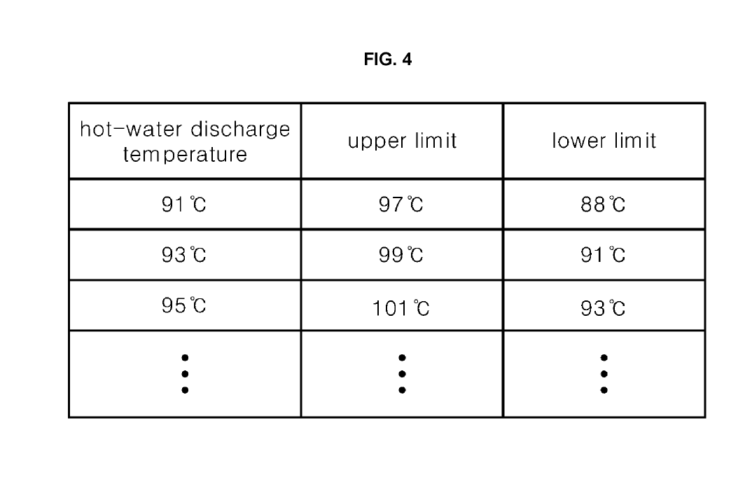

The control unit 208 determines the upper-limit temperature and lower-limit temperature corresponding to the hot-water discharge temperature according to the user's request for hot-water discharge. FIG. 4 is a temperature table showing the upper-limit temperature and the lower-limit temperature corresponding to the hot-water discharge temperature in one embodiment of the present disclosure. The control unit 208 may refer to the previously stored temperature table as illustrated in FIG. 4, to determine the upper-limit temperature and lower-limit temperature corresponding to a currently-set hot-water discharge temperature, respectively. In one embodiment, the control unit 208 may employ a pre-stored relationship, to calculate the upper-limit temperature and the lower-limit temperature corresponding to the currently-set hot-water discharge temperature, respectively.

In one embodiment, the control unit 208 may update the upper-limit temperature value and lower-limit temperature value as stored in the pre-stored temperature table as shown in FIG. 4 during use of the water purifying device. For example, when the user requests hot-water discharge and, at the same time, the hot-water discharge temperature is set to 93° C., the control unit 208 sets the upper-limit temperature to 99° C. and the lower-limit temperature to 91° C. based on the temperature table in FIG. 4. At this time, a heating operation is performed. Thereafter, hot-water discharge is performed. At the same time, if the temperature of the water in the hot-water storage 210 measured via the temperature sensor 220 is not maintained at 93° C., the control unit 208 may update to a new value at least one of the upper-limit temperature and the lower-limit temperature corresponding to the hot-water discharge temperature of 93° C.

For example, when the temperature of the water in the hot-water storage 210 as measured at the hot-water discharge process is determined to be 94° C. in the above example, the control unit 208 lowers the upper-limit temperature of 99° C. by 1° C. or lowers the lower-limit temperature of 91° C. by 1° C. This process may be a calibration process. With the temperature being calibrated, heating operation is performed. When the temperature of the water in the hot-water storage 210 in the water discharge process is maintained at 93° C. via the calibration of the upper-limit temperature or the lower-limit temperature, the control unit 208 updates the upper or lower-limit temperature value as stored in the table of FIG. 4 to the calibrated value. Updating the above temperature table in this way may lead to more accurate temperature control.

When the upper-limit temperature and lower-limit temperature have been determined by control unit 208, the control unit 208 controls driving of the drive unit 206 based on the determined upper-limit temperature and lower-limit temperature. As described above, if the temperature of the water inside the hot-water storage 210 is equal to or above the upper-limit temperature, the control unit 208 may stop the drive unit 206 so that the switching signal is not supplied to the heating module 204. Conversely, if the temperature of the water inside the hot-water storage is equal to or below the lower-limit temperature, the control unit 208 may drive the drive unit 206 such that the switching signal is supplied to the heating module 204.

In accordance with the present disclosure, while the heating operation is performed to heat the water in the hot-water storage 210 under the control by the control unit 208, the operating frequencies corresponding to the switching operations of the switching elements provided in the heating module 204 may be maintained to be equal to each other for all of the spaced temporal heating periods.

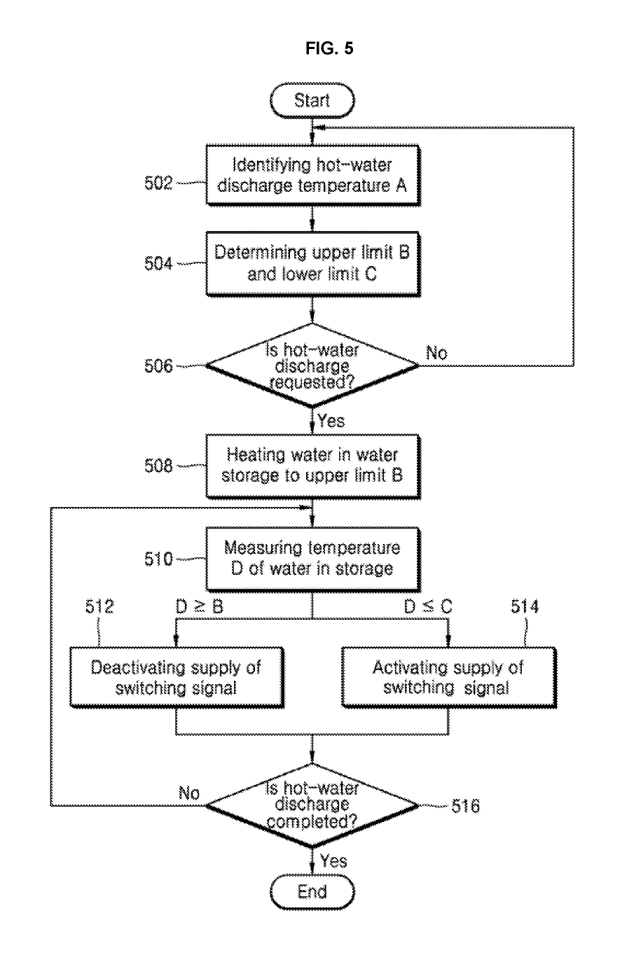

Hereinafter, a hot-water discharge process by the water-purifying device according to the present disclosure will be described with reference to FIGS. 1 to 5. FIG. 5 is a flow chart of a method for controlling a water-purifying device according to one embodiment of the present disclosure.

Referring to FIG. 5, the control unit 208 first identifies a preset hot-water discharge temperature A (502). As described above, the hot-water discharge temperature A may be preset at the time of manufacturing the water-purifying device, or may be arbitrarily set by the user.

Then, the control unit 208 determines (504) an upper-limit temperature B and a lower-limit temperature C based on the identified hot-water discharge temperature A. To this end, the control unit 208 may refer to the temperature table as illustrated in FIG. 4 or employ a pre-defined associated relationship, to determine the upper-limit temperature B and the lower-limit temperature C corresponding to the identified hot-water discharge temperature A, respectively.

Next, the control unit 208 checks (506) the hot-water discharge request from the user. If there is no hot-water discharge request, the control unit 208 may again perform the identification (502) of the hot-water discharge temperature A and the determination (504) of the upper-limit temperature B and the lower-limit temperature C.

In this connection, in FIG. 5, after the control unit 208 performs the identification (502) of the hot-water discharge temperature A and the determination (504) of the upper-limit temperature B and the lower-limit temperature C, the control unit checks (506) the hot-water discharge request from the user. However, the present disclosure is not limited thereto. In one embodiment, the control unit, after confirming the hot-water discharge request from the user, the control unit may perform the identification of the hot-water discharge temperature A and the determination of the upper-limit temperature B and the lower-limit temperature C.

Referring again to FIG. 5, when it is determined in operation 506 that there is a hot-water discharge request from the user, the control unit 208 drives the drive unit 206 until the temperature D of the water in the hot-water storage reaches the upper-limit temperature B. Thus, the drive unit causes the heating module 204 to heat the water in the hot-water storage 210 (508).

The control unit 208 then uses the temperature sensor 220 to measure the temperature D of the water in the hot-water storage (510). If it is determined from the result of the measurement operation 510 that the temperature D of water in the hot-water storage is equal to or higher than the upper-limit temperature B, the control unit 208 interrupts (512) the supply of the switching signal from the drive unit 206 to the heating module 204. As a result, the heating operation by the heating module 204 is stopped.

On the other hand, if it is confirmed from the result of the measurement operation 508 that the temperature D of the water in the hot-water storage is lower than or equal to the lower-limit temperature C, the control unit 208 causes the drive unit 206 to supply (514) the switching signal to the heating module 204. As a result, the heating operation by the heating module 204 is resumed.

After such control of the switching signal supply, the control unit 208 determines whether the hot-water discharge at the user's request has been completed (514). When it is determined from the result of the determination operation 514, that the hot-water discharge has been completed, the control unit 208 ends the heating operation. Otherwise, the control unit 208 repeats operation 510 to operation 514.

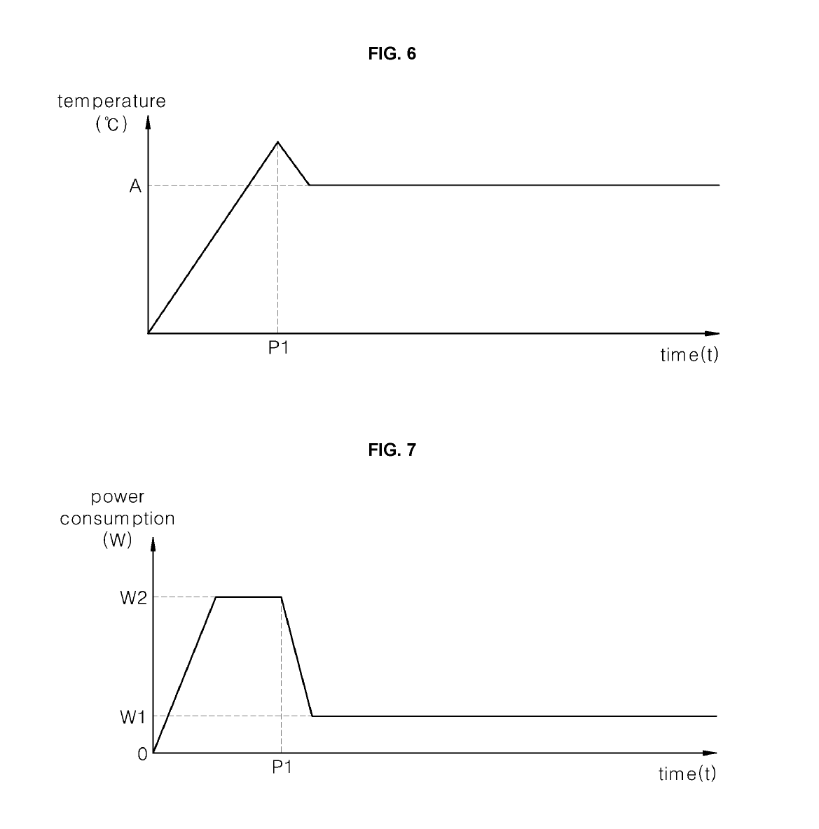

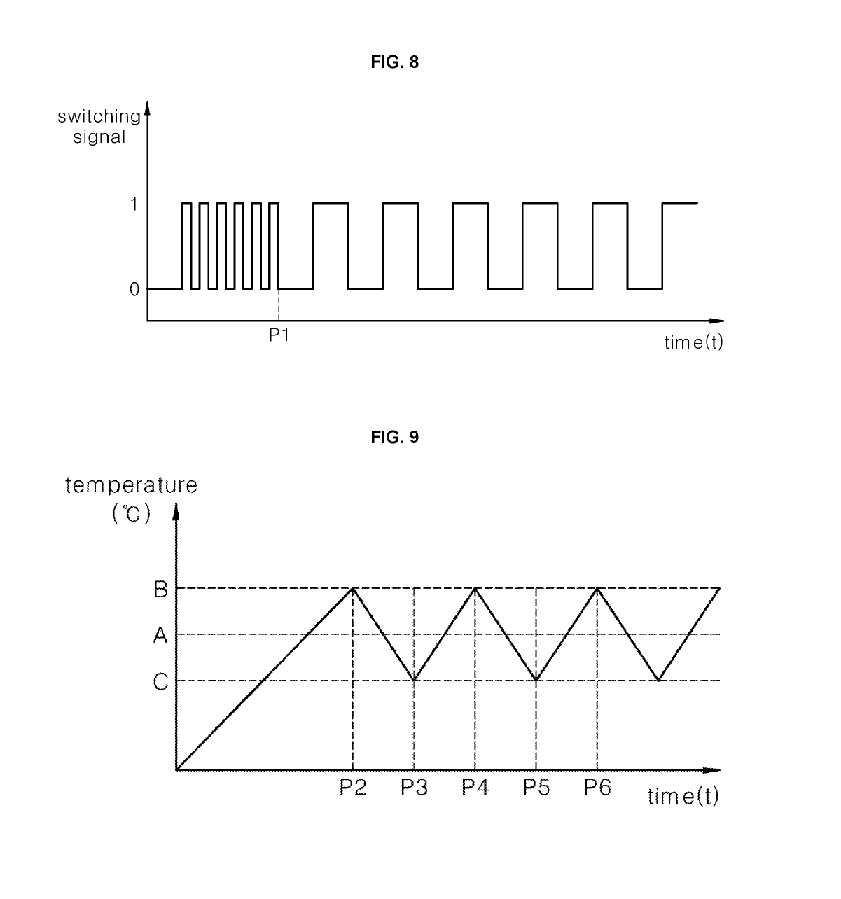

FIG. 6 is a graph showing a temperature change of water over time when a conventional water purifying device heats water in a hot-water storage. FIG. 7 is a graph showing a change in power consumption over time when a conventional water purifying device heats water in a hot-water storage. FIG. 8 is a graph showing a change in a switching signal over time when a conventional water purifying device heats water in a hot-water storage.

Referring to FIG. 6 and FIG. 8, a control unit in the conventional water purifying device drives, in response to a hot-water discharge request by the user, a heating module based on a predetermined operating frequency up to a temporal point P1, to perform a heating operation, such that the temperature of the water in the hot-water storage is above or equal to the hot-water discharge temperature A. Thereafter, if it is ascertained that the temperature of the water in the hot-water storage has risen above the hot-water discharge temperature A at the temporal point P1, the control unit continuously drives, after the temporal point P1, the heating module with the operating frequency of the heating module being lowered, as illustrated in FIG. 8. A reason why the operating frequency of the heating module may be lowered may be as follows: an amount of heat needed to maintain the water at the hot-water discharge temperature A is relatively low, compared to an amount of heat required to initially raise the temperature of the water above the hot-water discharge temperature A.

In the conventional water purifying device, after the temperature of the water in the hot-water storage rises above the hot-water discharge temperature A, the operation of the heating module continues until the hot-water discharge is terminated in order to keep the water temperature close to the hot-water discharge temperature A. FIG. 8 illustrates the change in power consumption resulting from the continuous operation.

As illustrated in FIG. 8, a maximum W2 of power is consumed to initially raise the temperature of the water above the hot-water discharge temperature A. Subsequently, from the temporal point P1, the heating module is driven continuously at a relatively low operating frequency to maintain the water temperature at the hot-water discharge temperature A. Therefore, power corresponding to W1 is continuously consumed until the hot-water discharge is terminated.

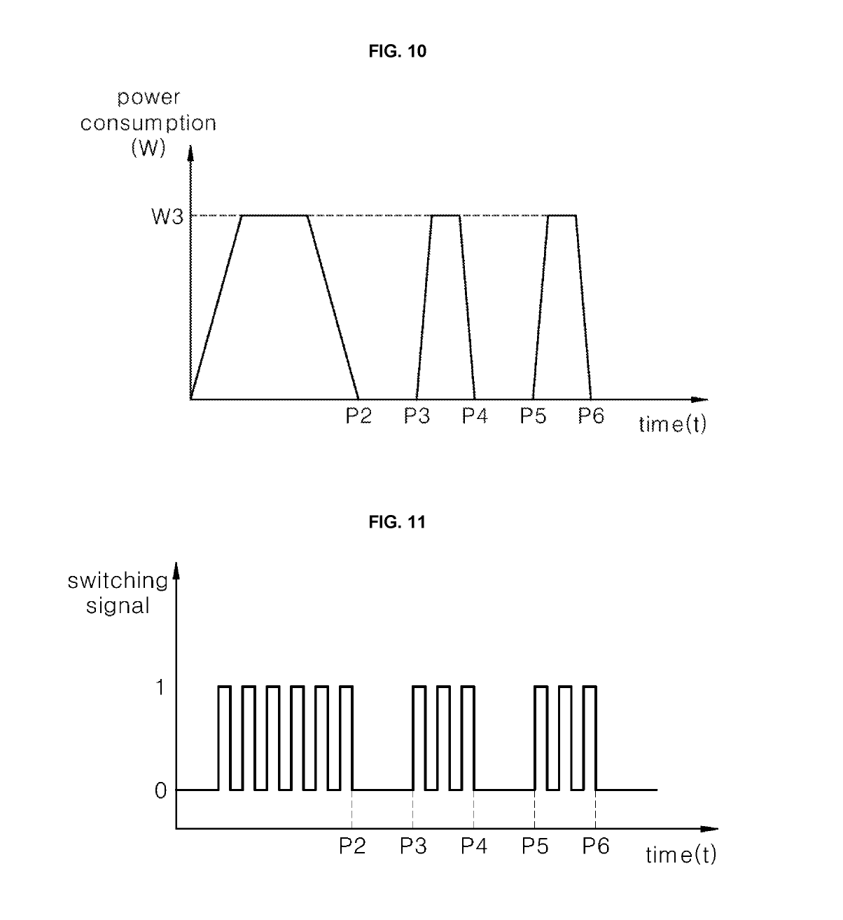

FIG. 9 is a graph showing a temperature change of water over time as the water-purifying device according to the present disclosure heats water in a hot-water storage. FIG. 10 is a graph showing a change in power consumption over time when the water-purifying device according to the present disclosure heats water in a hot-water storage. FIG. 11 is a graph showing a change in a switching signal over time when the water-purifying device according to the present disclosure heats water in the hot-water storage.

Referring to FIG. 9 and FIG. 11, a control unit in the conventional water purifying device drives, in response to a hot-water discharge request by the user, a heating module based on a predetermined operating frequency up to a temporal point P2, to perform a heating operation, such that the temperature of the water in the hot-water storage is above or equal to the hot-water discharge temperature A. Thereafter, if it is ascertained that the temperature of the water in the hot-water storage has risen above an upper limit temperature B or to be equal to the temperature B at the temporal point P2, the control unit completely stops the operation of the heating module from the temporal point P2, as illustrated in FIG. 11. Therefore, as shown in FIG. 10, the power consumption of the heating module in a period P2 to P3 is zero.

Referring again to FIG. 9, for the period P2 to P3, the heating operation by the heating module is not performed. Therefore, the temperature of water in the hot-water storage gradually drops. Thereafter, if it is ascertained that the water temperature has dropped below the lower-limit temperature C at the temporal point P3, the control unit restarts the heating operation by restarting the heating module. Accordingly, the water temperature gradually increases until the temporal point P4 where the water temperature reaches the upper-limit temperature B.

Thus, when the heating operation is resumed at the temporal point P3, the operating frequency of the switching signal applied to the heating module is equal to the operating frequency of the switching signal as applied for a duration from the temporal point at which the hot-water discharge is requested to the temporal point P2, as illustrated in FIG. 11. In this manner, by setting the operating frequency since the point P3 to be equal to the previous operating frequency, the temperature of the water may be raised to the upper-limit temperature B in a short time.

Thereafter, if it is determined that the temperature of the water in the hot-water storage has risen above the upper-limit temperature B or to be equal to the temperature B at a temporal point P4, the control unit again stops the heating module. Thereafter, if it is determined that the temperature of the water has dropped below the lower-limit temperature C or to be equal thereto at a temporal point P5, the control unit resumes the heating operation by driving the heating module again. At a temporal point P6 where the temperature of the water in the hot-water storage rises above the upper-limit temperature B or to be equal thereto, the operation of the heating module is stopped again. This process continues until the hot-water discharge from the user is terminated.

Under the control as specified above by the control unit according to the present disclosure, the power consumption is reduced as follows: specifically, as illustrated in FIG. 10, only in each of the periods in which the water in the hot-water storage has risen to the upper-limit temperature B from the lower-limit temperature C, that is, periods 0 to P2, P3 to P4, and P5 to P6 in which the heating module is activated, the power corresponding to W3 is consumed. Therefore, a relatively small amount of power is consumed compared with the conventional case.

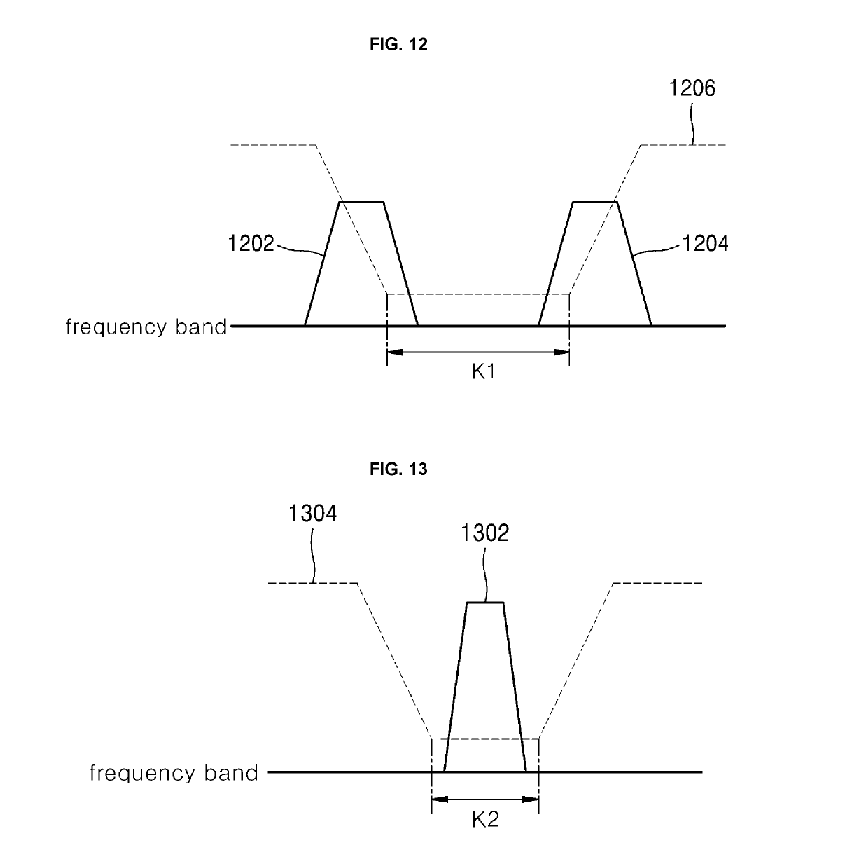

FIG. 12 is a graph showing a frequency band as covered by a filter circuit used in the conventional water purifying device according. In order to eliminate the switching noise caused by the switching operation of the heating module for the heating of the water purifying device as described above, the heating module or drive unit may be equipped with a filter circuit. Such a filter circuit may cover different frequency ranges, based on the operating frequencies of the switching signals applied thereto. In this regard, as described above with reference to FIG. 8, the heating module of the conventional water purifying device is driven at different operating frequencies for previous and subsequent periods to the temporal point P1. FIG. 12 indicates operating frequencies 1202 and 1204 of the switching signals as applied to the heating module of the conventional water purifying device, and a frequency band 1206 covered by the filter circuit used to remove the switching noise due to the application of the switching signals.

As described above, the heating module of the conventional water purifying device operates at a relatively low frequency 1202 for the previous period to the temporal point P1 and at a relatively high frequency 1204 for the subsequent period to the temporal point P1, as shown in FIG. 8. Therefore, the filter circuit used in the heating module of the conventional water purifying device must cover a relatively wide frequency band K1.

As the filter circuit covers a wider frequency band, there is a problem that a unit price of the filter circuit increases. FIG. 13 is a graph showing a frequency band as covered by a filter circuit used in the water purifying device according to the present disclosure.

As illustrated above in FIG. 11, the heating module according to the present disclosure always operates at the same operating frequency in each of all of the periods when the module is activated. Therefore, as illustrated in FIG. 13, an operating frequency band K2 of the heating module of the water purifying device according to the present disclosure is much narrower than in the conventional water purifying device. Therefore, the frequency band K2 in accordance the present disclosure is much narrower than the frequency band K1 of the filter circuit used in the conventional water-purifying device illustrated in FIG. 12.

As a result, according to the present disclosure, the frequency band that the filter circuit used in the heating module of the water purifying device must cover is much narrower than in the conventional device. Thus, a cost of the filter circuit according to the present disclosure is lowered, and, hence, a manufacturing cost of the water purifying device is also lowered.

Aspects of the present disclosure provide a water-purifying device and a method for controlling the water-purifying device, whereby the switching loss and switching noise due to the switching operation may be reduced by repeatedly driving and stopping the heating module to maintain the temperature of water in the hot-water storage at a hot-water discharge temperature.

The aspects of the present disclosure are not limited to the above-mentioned aspects. Other aspects of the present disclosure, although not mentioned above, may be understood from the descriptions and more clearly understood from the embodiments of the present disclosure. Further, it will be readily appreciated that the aspects of the present disclosure may be realized by features and combinations thereof as disclosed in the claims.

According to the present disclosure, in order to maintain the hot-water discharge temperature of water in the hot-water storage upon the hot-water discharge request from the user, an upper-limit temperature and lower-limit temperature corresponding to the hot-water discharge temperature are determined. Thus, the water-purifying device according to the present disclosure may drive the heating module based on the upper-limit temperature and lower-limit temperature, thereby to overcome the drawbacks caused by the continuous driving of the heating module according to the conventional device.

More specifically, when the upper-limit temperature and the lower-limit temperature corresponding to the hot-water discharge temperature are determined, the water-purifying device according to the present disclosure drives the heating module until the water temperature in the hot-water storage reaches the upper-limit temperature. If the temperature of the water in the hot-water storage rises above or to the upper-limit temperature, the heating module stops operating. Thus, the temperature of the water in the hot-water storage is gradually lowered.

Thereafter, when the temperature of the water in the hot-water storage falls below or to the lower-limit temperature, the heating module is driven again. The operation of the heating module continues until the water temperature in the hot-water storage reaches the upper-limit temperature. As a result, the water-purifying device according to the present disclosure repeats the driving and stopping of the heating module, without continuously driving the heating module as in the conventional device, in order to keep the water temperature in the hot-water storage constant.

In particular, the water in the hot-water storage is heated up in spaced temporal periods. In this connection. all of operating frequencies corresponding to switching operations of at least one switching element in the heating module for all of the spaced temporal periods are kept to be equal to each other. Therefore, the present disclosure may allow using a filter circuit that covers a relatively narrow frequency band as compared with the conventional device, in order to reduce the switching noise.

In a first aspect of the present disclosure, there is provided a water-purifying device comprising: a hot-water storage; a working coil provided on the hot-water storage for heating water in the hot-water storage; a heating module including at least one switching element, wherein the heating module is configured for supplying a resonant current to the working coil via switching operation of the at least one switching element; a drive unit configured for supplying a switching signal to the heating module, wherein the switching signal activates the switching operation of the at least one switching element; and a control unit configured for: determining upper-limit and lower-limit temperatures corresponding to a predetermined hot-water discharge temperature; and controlling the supply of the switching signal from the drive unit to the heating module based on the upper-limit temperature and the lower-limit temperature.

In one embodiment of the device, when a temperature of water in the hot-water storage is above or equal to the upper-limit temperature, the control unit is configured to control the drive unit such that the switching signal is not supplied to the heating module, wherein when the temperature of water in the hot-water storage is below or equal to the lower-limit temperature, the control unit is configured to control the drive unit such that the switching signal is supplied to the heating module.

In one embodiment of the device, the operating frequency for the switching operation of the heating module is kept constant while the water in the hot-water storage is heated. In one embodiment of the device, the control unit is configured to determine the upper-limit temperature and the lower-limit temperature such that a temperature of mixed water between water having the upper-limit temperature and water having the lower-limit temperature is substantially equal to the hot-water discharge temperature.

In one embodiment of the device, the device further includes a current interrupter, wherein the current interrupter is provided between the heating module and the drive unit, wherein the current interrupter is configured to interrupt the supply of the switching signal from the drive unit to the heating module under control by the control unit.

In a second aspect of the present disclosure, there is provided a method for controlling a water-purifying device, wherein the device includes a hot-water storage and a heating module, the method comprising: identifying a predetermined hot-water discharge temperature; determining upper-limit and lower-limit temperatures corresponding to the hot-water discharge temperature; and controlling supply of a switching signal to the heating module, based on the upper-limit temperature and the lower-limit temperature, wherein the heating module is activated based on the switching signal to heat water in the hot-water storage.

In one embodiment of the method, controlling the supply of the switching signal to the heating module, based on the upper-limit temperature and the lower-limit temperature includes: when a temperature of water in the hot-water storage is above or equal to the upper-limit temperature, deactivating the supply of the switching signal to the heating module; and when the temperature of water in the hot-water storage is below or equal to the lower-limit temperature, activating the supply of the switching signal to the heating module.

In one embodiment of the method, the method includes: heating water in the hot-water storage in spaced temporal periods; and maintaining all of operating frequencies corresponding to switching operations of the heating module to be equal to each other for all of the spaced temporal periods. In one embodiment of the method, determining the upper-limit and lower-limit temperatures corresponding to the hot-water discharge temperature includes determining the upper-limit temperature and the lower-limit temperature such that a temperature of mixed water between water having the upper-limit temperature and water having the lower-limit temperature is substantially equal to the hot-water discharge temperature.

In one embodiment of the method, the device further includes a drive unit, and a current interrupter provided between the heating module and the drive unit, wherein controlling the supply of the switching signal to the heating module includes allowing the current interrupt to interrupt the supply of the switching signal from the drive unit to the heating module.

In accordance with the present disclosure, the switching loss and switching noise due to the switching operation may be reduced by repeatedly driving and stopping the heating module to maintain the temperature of water in the hot-water storage at a hot-water discharge temperature.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the above description, numerous specific details are set forth in order to provide a thorough understanding of the present disclosure. The present disclosure may be practiced without some or all of these specific details. Examples of various embodiments have been illustrated and described above. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A water-purifying device comprising:
a hot-water storage tank;
a working coil provided on the hot-water storage tank to heat water in the hot-water storage tank;
a resonant current generation circuitry including at least one switching element, wherein the resonant current generation circuitry supplies a resonant current to the working coil via a switching operation of the at least one switching element;
a drive circuitry that supplies a switching signal to the resonant current generation circuitry, wherein the switching signal activates the switching operation of the at least one switching element; and
a controller that:
determines upper-limit and lower-limit temperatures corresponding to a particular hot-water discharge temperature; and
manages a supply of the switching signal from the drive circuitry to the resonant current generation circuitry based on the upper-limit temperature and the lower-limit temperature.

2. The water-purifying device of claim 1, further comprising:
a temperature sensor that determines a temperature of the water in the hot-water storage tank,
wherein when the temperature of water in the hot-water storage tank is above or equal to the upper-limit temperature, the controller manages the drive circuitry such that the switching signal is not supplied to the resonant current generation circuitry, and
wherein when the temperature of water in the hot-water storage tank is below or equal to the lower-limit temperature, the controller manages the drive circuitry such that the switching signal is supplied to the resonant current generation circuitry.

3. The water-purifying device of claim 1, wherein the switching operation of the resonant current generation circuitry is maintained at a constant operating frequency while the water in the hot-water storage tank is being heated.

4. The water-purifying device of claim 1, wherein the controller further determines the upper-limit temperature and the lower-limit temperature such that a temperature of mixture of water having the upper-limit temperature and water having the lower-limit temperature is substantially equal to the hot-water discharge temperature.

5. The water-purifying device of claim 1, wherein controller further selectively interrupts a supply of the switching signal from the drive circuitry to the resonant current generation circuitry based on the upper-limit temperature and the lower-limit temperature.

6. The water-purifying device of claim 1, wherein the resonant current generation circuitry further includes an inverter to convert a direct current (DC) voltage to an alternating current (AC) voltage to form the resonant current, and the at least one switching element is included in the inverter.

7. The water-purifying device of claim 6, wherein the at least one switching element includes four switching elements, and the drive circuitry supplies four switching signals, respectively, to the four switching elements.

8. The water-purifying device of claim 7, wherein the four switching elements include a first switching element and a third switching element that are positioned in series with each other, and a second switching element and a fourth switching element that are positioned in series with each other.

9. The water-purifying device of claim 6, wherein the inverter further includes a capacitor connected to one end of the working coil, and a capacitor connected to a second end of the working coil.

10. The water-purifying device of claim 6, wherein the at least one switching element includes a first switching element and a third switching element that are positioned in series with each other, and a second switching element and a fourth switching element that are positioned in series with each other, and
wherein the inverter further includes a capacitor connected to the working coil and between the first switching element and third switching element, and a capacitor connected to the working coil and between the second switching element and the fourth switching element.

11. The water-purifying device of claim 6, wherein the resonant current generation circuitry further includes a smoothing circuit that smooths the DC voltage supplied to the inverter.

12. The water-purifying device of claim 11, wherein the smoothing circuit includes an inductor and a capacitor that are connected in series with each other.

13. The water-purifying device of claim 6, wherein the resonant current generation circuitry further includes a rectifying circuit that rectifies power supplied from an external power source to form the DC power.

14. The water-purifying device of claim 13, wherein the rectifying circuit includes one or more diodes.

15. A method to control a water-purifying device, wherein the water-purifying device includes a hot-water storage tank and a resonant current generation circuitry, the method comprising:
identifying a hot-water discharge temperature;
determining upper-limit and lower-limit temperatures corresponding to the hot-water discharge temperature; and
controlling a supply of a switching signal to the resonant current generation circuitry based on the upper-limit temperature and the lower-limit temperature, wherein the resonant current generation circuitry is activated based on the switching signal to heat water in the hot-water storage tank.

16. The method of claim 15, wherein controlling the supply of the switching signal to the resonant current generation circuitry based on the upper-limit temperature and the lower-limit temperature includes:
when a temperature of water in the hot-water storage tank is above or equal to the upper-limit temperature, deactivating the supply of the switching signal to the resonant current generation circuitry; and
when the temperature of water in the hot-water storage tank is below or equal to the lower-limit temperature, activating the supply of the switching signal to the resonant current generation circuitry.

17. The method of claim 15, wherein an operating frequency for a switching operation of the resonant current generation circuitry is kept constant while the water in the hot-water storage tank is being heated.

18. The method of claim 15, wherein determining the upper-limit and lower-limit temperatures corresponding to the hot-water discharge temperature includes determining the upper-limit temperature and the lower-limit temperature such that a temperature of a mixture of water having the upper-limit temperature and water having the lower-limit temperature is substantially equal to the hot-water discharge temperature.

19. The method of claim 15, wherein the water-purifying device further includes a drive circuitry, wherein controlling the supply of the switching signal to the resonant current generation circuitry includes interrupting the supply of the switching signal from the drive circuitry to the resonant current generation circuitry.

20. A water-heater comprising:
a hot-water storage tank;
a working coil provided on the hot-water storage tank to heat water in the hot-water storage tank;
a resonant current generation circuitry including at least one switching element, wherein the resonant current generation circuitry supplies a resonant current to the working coil via a switching operation of the at least one switching element;
a drive circuitry that supplies a switching signal to the resonant current generation circuitry, wherein the switching signal activates the switching operation of the at least one switching element;
a temperature sensor that determines a temperature of the water in the hot-water storage tank; and
a controller that manages a supply of the switching signal from the drive circuitry to the resonant current generation circuitry based on a temperature of the water, an upper-limit temperature, and a lower-limit temperature, wherein:
when the temperature of water in the hot-water storage tank is above or equal to the upper-limit temperature, the controller manages the drive circuitry such that the switching signal is not supplied to the resonant current generation circuitry, and
when the temperature of water in the hot-water storage tank is below or equal to the lower-limit temperature, the controller manages the drive circuitry such that the switching signal is supplied to the resonant current generation circuitry.
